(19) United States
(12) Patent Application Publication
(10) Pub. No.: US 2013/0020011 A1
(43) Pub. Date: Jan. 24, 2013

(54) DOUBLE-SIDED CONSTRUCTION TAPE FOR AIR SEALING BETWEEN CONDITIONED AND UNCONDITIONED SPACES

(71) Applicant: Robert C. Eipert, Berea, KY (US)

(72) Inventor: Robert C. Eipert, Berea, KY (US)

(73) Assignee: Bremen, Inc, BEREA, KY (US)

(21) Appl. No.: 13/548,529

(22) Filed: Jul. 13, 2012

Related U.S. Application Data
(60) Provisional application No. 61/572,565, filed on Jul. 18, 2011.

(51) Int. Cl. C09J 7/02; C09J 123/18; E04F 19/04; B32B 3/10; B32B 33/00

(52) U.S. Cl. 156/71; 428/354; 428/195.1; 428/41.8

(57) ABSTRACT

The present invention relates to double-sided, construction tape used to prevent unwanted air flow between conditioned and unconditioned spaces of a structure, which improves the structure's energy efficiency and comfort. The inner surface of the construction tape includes adhesive and non-adhesive areas. The outer surface of the tape includes an adhesive area and is overlaid with a release material. The release material may be perforated to assist in its removal. The tape is applied during construction to seal gaps between adjoining construction materials. The tape may be applied along the top, bottom, or sides of walls, or around other various openings, such as HVAC or lights.

### CROSS-REFERENCE TO RELATED APPLICATION

This application is a non-provisional of U.S. application Ser. No. 61/572,565, filed Jul. 18, 2011, the entire disclosure of which is expressly incorporated by reference herein.

### FIELD OF THE INVENTION

The invention relates to a product and method for improving the energy efficiency and comfort of structures by creating a barrier between conditioned and unconditioned spaces.

### BACKGROUND

When a structure is built, many small gaps are created between adjoining materials, such as around windows and doors, between the walls and the foundation, and between the wooden frame and the drywall. Sealing these gaps can greatly increase a structure's energy efficiency by preventing the flow of air and moisture, which also improves the comfort of the structure. However, these gaps may be difficult to seal as the construction of the structure advances. For example, once the ceiling cladding is installed, it is very difficult to seal the gap created between the top plate and the wall cladding because of accessibility issues (e.g. low roof pitches, electrical wiring, ducts, roof cross-beams, and other mechanical hardware and obstacles that may be found in an attic).

Currently, builders attempt to seal this top plate gap using caulk and/or spray foam. These products are expensive and ineffective if the gap between the top plate and the ceiling cladding opens directly into the attic without the necessary backing to stop the free-flow of caulk and/or spray foam into the attic. Such a situation would fail to seal the gap and waste material and labor cost.

Thus, there is a need for a reliable, inexpensive, easy-to-use product for sealing the gaps that compromise the energy envelop of a structure.

### SUMMARY

The present invention relates to double-sided construction tape for preventing air flow through gaps created during the construction process, thereby improving the thermal efficiency and comfort of a structure. The tape is constructed from flexible and durable material that adheres to multiple construction surfaces (e.g. wood, metal, concrete, wood composite or structural lumber, plastic, etc.) in a variety of temperature and moisture conditions. The tape comprises an adhesive area on the inner surface of the tape with adhesive that extends from the top edge of the tape toward the center for the length of the tape and a nonadhesive area on the inner surface of the tape that extends from the bottom edge toward the center for the length of the tape. The outer surface of the tape comprises an adhesive area with adhesive extending from the bottom edge toward the center for the length of the tape, and may alternatively cover the entire outer surface of the tape. The outer surface of the tape is adhered to a release material, such as release paper or release film. The release material may be perforated along the medial axis to assist in proper tearing.

Creating a seal with the tape of the current invention comprises applying the adhesive area of the inner surface of the tape to the vertical face of a top or bottom plate prior to the application of cladding, such as drywall. The nonadhesive area of the inner surface notably lacks adhesive to prevent accidental bonding of this area to the studs, subfloor or other construction materials during application. Once the tape is applied to the top or bottom plate, cladding is affixed to the framing, such that the adhesive area of inner surface of the tape is between the cladding (e.g. drywall) and the top or bottom plate. After the cladding is installed, the lower portion of the release material is removed from the lower portion of the outer surface of the tape, exposing some of the outer surface adhesive area. The outer surface of the construction tape is then folded and adhered to the cladding. Cladding is then finished using conventional methods.

### BRIEF DESCRIPTION OF THE DRAWINGS

FIG. 1 shows a roll of the construction tape of the present invention.

FIGS. 2A-2C show the configurations of the inner and outer surface adhesive and nonadhesive areas.

FIG. 2D shows an example of the perforated release material.

FIG. 3 shows the air flow from unconditioned spaces to conditioned spaces caused by gaps between construction materials.

FIG. 4 shows the first step in the process of using the present invention to create a seal along a ceiling by applying the construction tape to the top plate prior to installing the ceiling cladding.

FIG. 5 shows the installation of ceiling cladding over a portion of the applied construction tape.

FIG. 6 shows removing of a portion of the release material to expose an adhesive area on the outer surface of the construction tape.

FIG. 7 shows adhering the exposed outer-surface adhesive area to the ceiling cladding.

FIG. 8 shows installing the wall cladding.

FIG. 9 shows using the tape to alternatively create a seal along a bottom plate.

FIG. 10 shows a side view of the seal created along the bottom plate.

### DETAILED DESCRIPTION

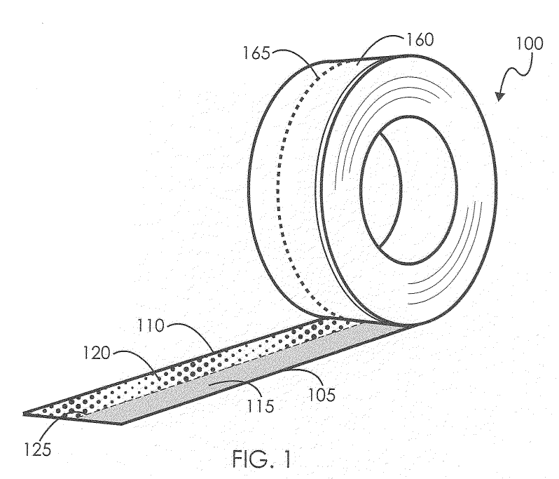

FIG. 1 illustrates the construction tape product 100 of the present invention. As shown in FIG. 1, the inner surface of the tape includes an adhesive area 115 that extends from the top edge 105 to the center 125 for the length of the tape, and a nonadhesive area 120 that extends from the bottom edge 110 to the medial axis 125 for the entire length of the tape.

As shown in FIG. 1, the outer surface of the tape is covered by a release material 160. The release material is shown with perforation 165 that extends the length of the tape along the approximate center. The location of the perforation may correspond to the boundary between the adhesive and nonadhesive areas on the inner surface of the tape, or to the depth of the cladding being applied to the ceiling, or other project-specific dimensions. Alternatively, the release material may not be perforated.

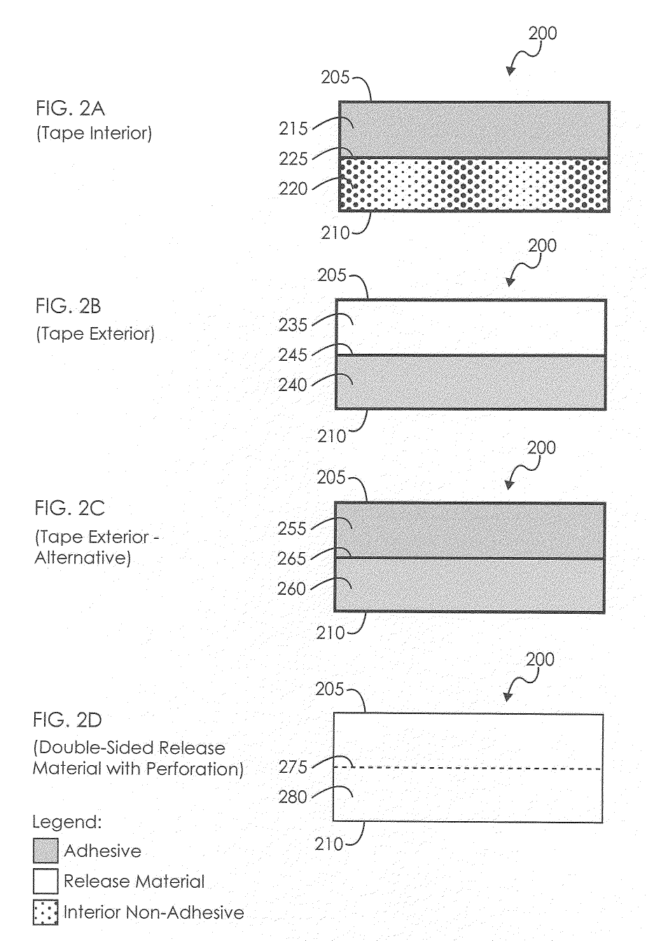

FIGS. 2A-2C illustrates the details of the inner and outer surfaces of the tape.

FIG. 2A shows the inner surface of tape 200 with a top edge 205 and bottom edge 210. The adhesive area 215 of the inner surface extends from top edge 205 toward the center 225 and the nonadhesive area 220 of the inner surface extends from the bottom edge 210 toward the center 225.

The width of construction tape 200 is determined by the required thicknesses of the adhesive and nonadhesive areas. The inner surface adhesive area 215 must be sufficiently wide to effectively bond to the top plate with a reduced risk of failure. Typically, the inner surface adhesive area 215 will be approximately as wide as the thickness of the ceiling cladding, though it is noted that the adhesive area 215 of the inner surface may be less wide than the thickness of the ceiling cladding for very thick cladding materials.

The nonadhesive area of the inner surface 220 must be wide enough to span most reasonable gaps between the top plate and the ceiling cladding and allow for enough overlap with the ceiling cladding that the adhesive area of the outer surface may create an effective seal with a reduced risk of failure. The nonadhesive area of the inner surface 220 may be slightly wider than the thickness of the wall cladding so that a visual inspection of the cladding installation can confirm the tape was properly installed. However, if the nonadhesive area of the inner surface 220 extends beyond the wall cladding too far, there is a risk that the finishing tape may not bond to the construction tape 200, resulting in visible imperfections in the finishing, negatively affecting the aesthetics within the room.

FIG. 2B illustrates one example of the outer surface of tape 200, in which the adhesive area 240 only covers the lower portion of the outer surface, extending from the bottom edge 210 toward the center 245 and may be approximately the same dimension as the nonadhesive area 220 on the inner surface.

Alternatively, FIG. 2C shows the outer surface of the tape is entirely coated with adhesive and does not include a nonadhesive area.

FIG. 2D shows the release material applied to the adhesive area of the outer surface of the tape. This release material prevents the adhesive of the outer surface from bonding to the adhesive on the inner surface while the tape is in a roll and prevents the adhesive area of the outer surface from becoming contaminated with dust and other construction debris. The release material may be release paper or release film. The release material may include a perforation along the length of the tape, and the perforation may exist along the center of the tape, correspond with the boundary of the adhesive/nonadhesive areas of the inner surface or correspond with the thickness of the cladding to be used. Alternatively, the release material may not be perforated, allowing the user to score the release material at an optimal, job-specific location.

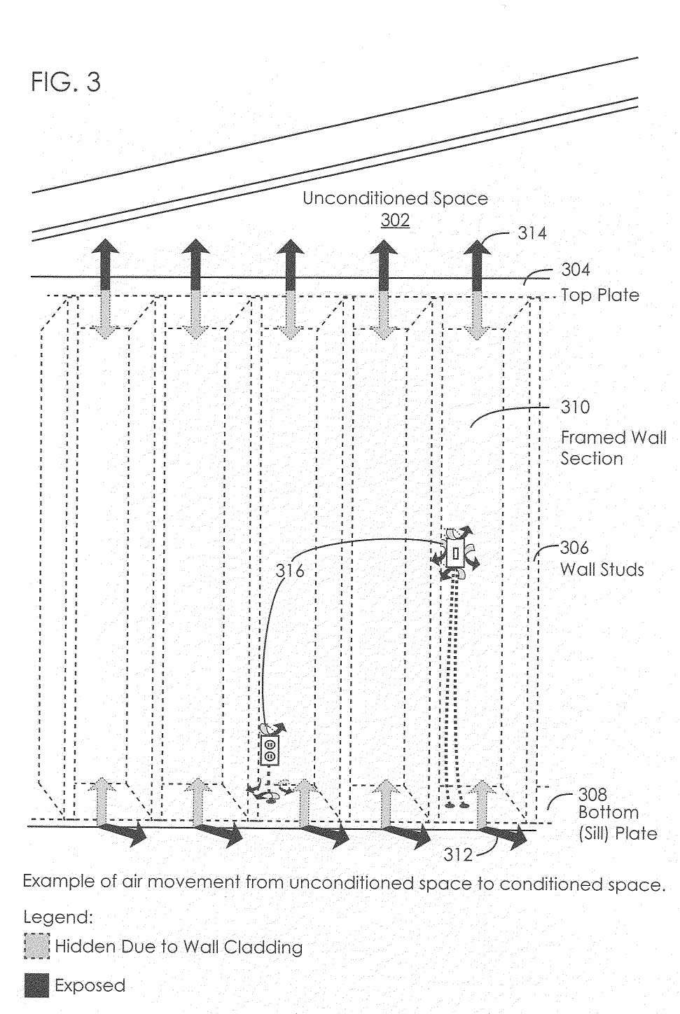

FIG. 3 illustrates how air penetrates a conventional structure that does not use the construction tape of the current invention. As shown in FIG. 3, air 314 may pass from the attic or other unconditioned space 302 into the wall cavities through gaps created during construction. The unconditioned air may heat or cool the wall cladding or may seep through other construction gaps, such as around light switches or receptacles 316 or along the intersection 312 of the bottom plate 308 and the floor. All scenarios of unconditioned air penetration will negatively impact the comfort and energy efficiency of the structure.

To prevent this undesirable flow of air, the construction tape of the present invention is applied to the top plate 304 of a wall section 310 and to the ceiling cladding (not shown) during construction. The construction tape creates a seal that prevents unconditioned air 314 (such as from an attic 302) from entering the chambers between the wall studs 306 within wall 310. It similarly prevents the conditioned air from being pulled from the conditioned space and deposited in an unconditioned space 302. The construction tape of the present invention is less expensive and consistently more effective for creating an air barrier than the current methods using caulk and/or spray foam.

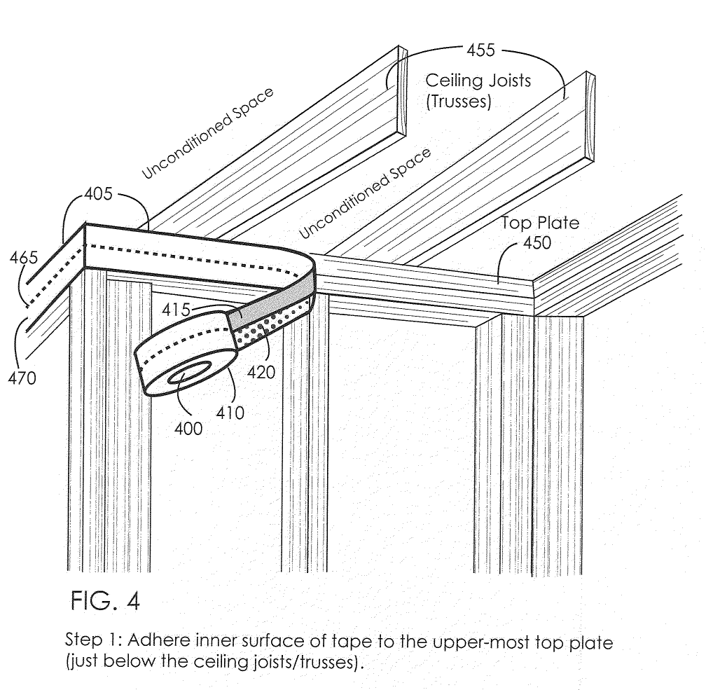

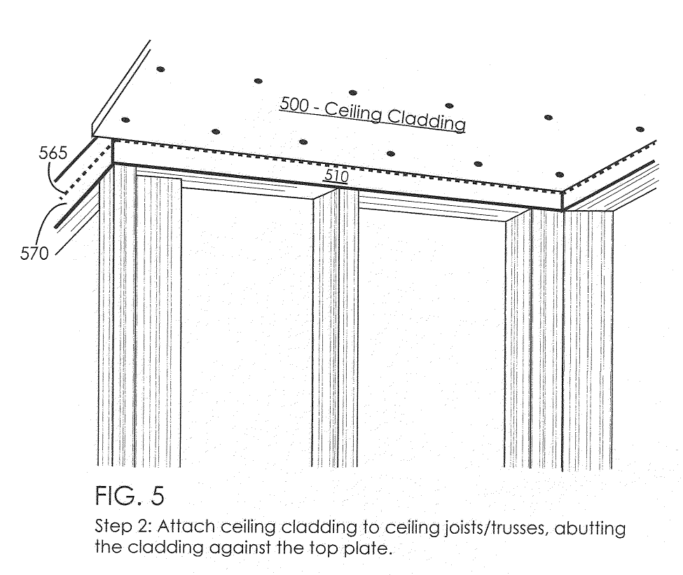

FIG. 4 illustrates the first step in applying the construction tape 400 of the present invention during construction. The tape 400 is applied to the top plates in rooms located directly below unconditioned space.

As tape 400 is unrolled, the inner surface of the tape, comprising adhesive area 415 and nonadhesive area 420, is exposed. Adhesive area 415 is applied to the upper portion of the top plate 450 of a framed wall such that the top edge 405 of the tape is adjacent to the ceiling joists/trusses 455. It is known that some walls are constructed using only one top plate, in which case the adhesive area 415 would be applied to the only top plate along the top edge of the top plate. Tape 400 is applied continuously over angles or abutments. As the tape is applied, the release material 470 and optional perforation 465 are visible on the top plate. Release material 470 remains intact until the ceiling cladding is installed to prevent dust or other construction materials from bonding to the adhesive area of the outer surface, located beneath the release material. This preserves the bonding ability of the adhesive and maintains the tape's ability to adhere properly against the ceiling cladding. Nonadhesive area 420 extending from the bottom edge 410 toward the center of the tape does not adhere to the frame or top plate.

FIG. 5 illustrates the second step of the process, in which the ceiling cladding 500 is attached to the joists and abuts the upper-most top plate upon which the adhesive area of the inner surface 415 was applied. Once cladding 500 is installed, only the lower portion 510 of release material 570 is visible. This exposed portion of the tape may be cut vertically on corners and in angles to allow for consistent application of the outer surface adhesive area to the ceiling cladding. This will reduce incidence of creases, folds, or bunching of the tape that may compromise the seal. If the release material includes perforation 565, this perforation will be located even with or just below the ceiling cladding for easy removal.

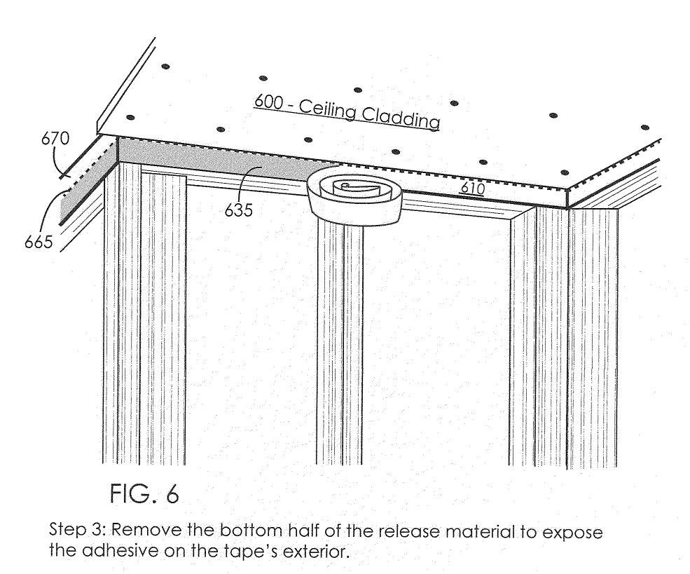

FIG. 6 illustrates the removal of the lower portion 610 of the release material 670, exposing the outer adhesive area 635. If the release material 670 includes perforation 665, the release material will be torn along this perforation. If the release material 670 does not include perforation, the release material will be gently scored along the surface of the ceiling cladding with a sharp instrument, such as a utility knife. Care must be taken to score only the release material as any scoring in the tape itself will compromise the seal and negate the purpose of the tape.

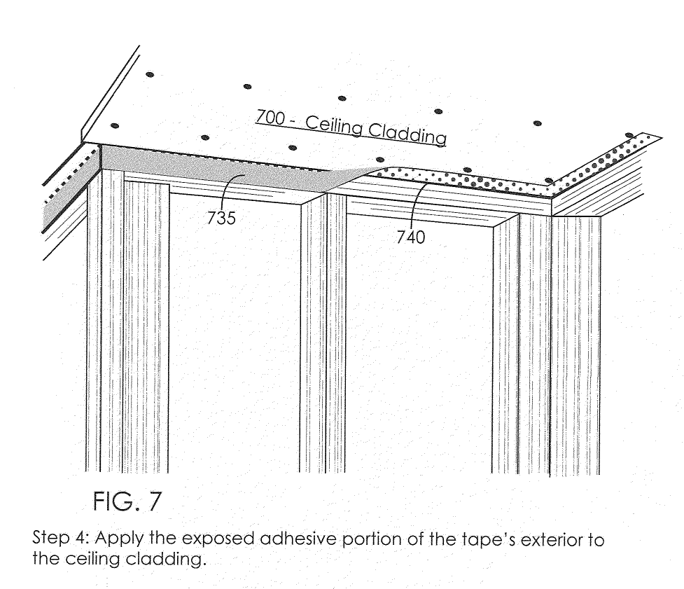

FIG. 7 shows folding the exposed portion of the tape to adhere the adhesive area of the outer surface 735 to the ceiling cladding 700. The nonadhesive area of the inner surface 740 is then visible on the ceiling cladding.

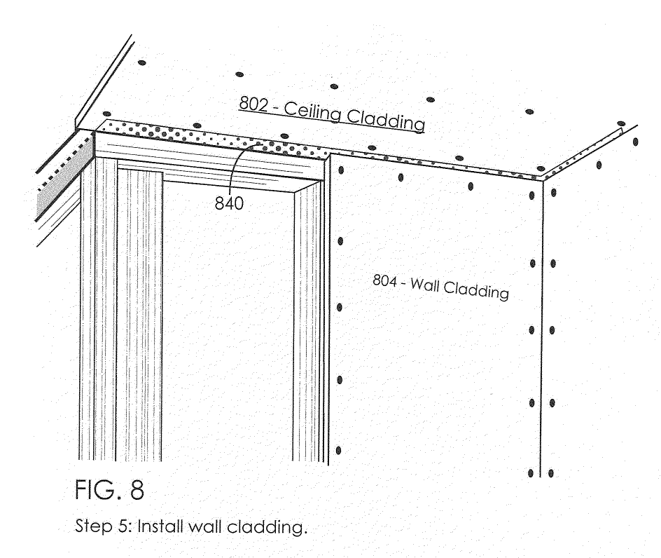

FIG. 8 shows the wall cladding 804 being installed. The nonadhesive area of the inner surface 840 is visible along the edge of the ceiling cladding 802 and should be slightly visible after the installation of the wall cladding 804.

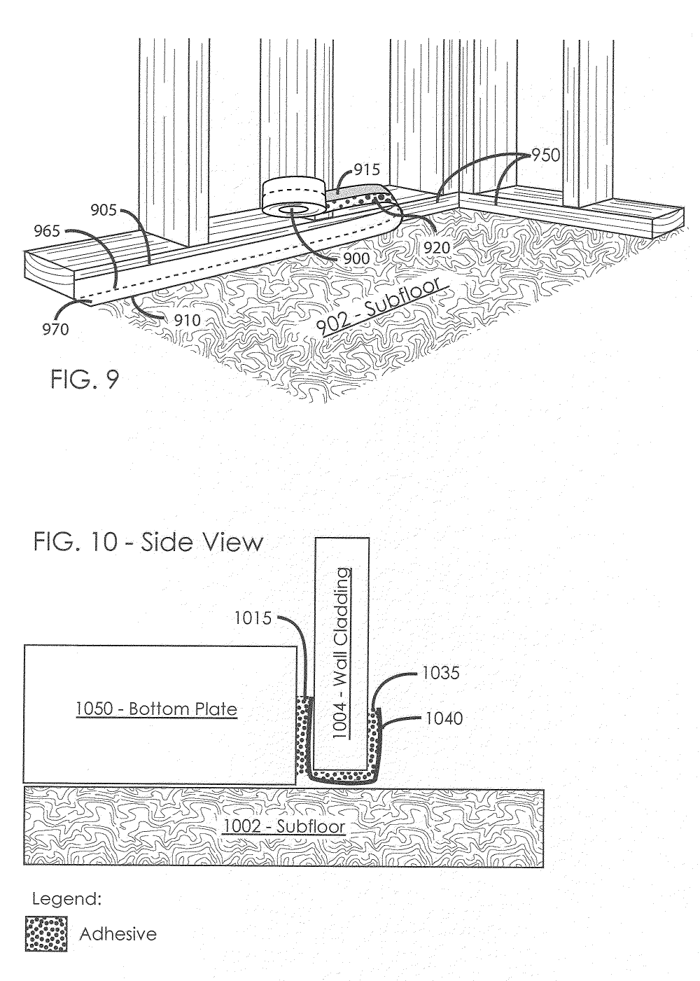

The construction tape of the present invention may also be used to create a seal between the bottom plate and the wall. This process is illustrated in FIG. 9.

As shown in FIG. 9, the construction tape 900 is applied to the bottom plate 950 along the subfloor 902 once the framed wall is installed. The adhesive area of the inner surface 915 is applied to the vertical face of the bottom plate 950. The top edge 905 of tape 900 is placed such that the adhesive area of the inner surface 915 is applied to the vertical edge of the top plate, and the nonadhesive area of the inner surface 920 lays on the subfloor. The release material 970 is visible and remains intact to protect the outer adhesive area from dust and construction debris.

Next, cladding is applied to the walls as shown in FIG. 8, which will cover the portion of the tape applied to the bottom plate and a portion of the tape on the floor, leaving a portion of the tape covered by release material visible. As discussed previously, the exposed portion of the tape may be cut perpendicular to the length of the tape on corners and angles to allow for consistent application of the outer surface adhesive area to the wall cladding, with reduced incidence of creases, folds, or bunching of the tape. If the release material 970 includes perforation 965, this perforation may be located approximately even with the surface of the wall cladding for easy removal. If the release material 970 does not include perforation, the release material will be gently scored along the surface of the ceiling cladding with a sharp instrument, such as a utility knife. Care must be taken to score only the release material as any scoring in the tape itself will compromise the seal and negate the purpose of the tape.

Once the adhesive area of the outer surface is exposed, the exposed portion of the tape is folded up and the adhesive area of the outer surface is adhered to the wall cladding. The nonadhesive area of the inner surface is then visible along the bottom of the wall.

FIG. 10 shows a side view of the bottom-plate application of the construction tape. The adhesive area of the inner surface 1015 is applied to the vertical face of the bottom plate and the nonadhesive area of the inner surface 1040 sets on the floor. Once the wall cladding 1004 is installed, the adhesive area of the outer surface 1035 is exposed and adhered to the bottom of the wall cladding 1004, making the nonadhesive area of the inner surface 1040 visible along the bottom of the wall cladding 1004.

The materials of the construction tape of the present invention may include butyl, polybutal, vinyl, or the like. The materials used must withstand a wide range of temperatures and moisture conditions. It is important that the tape be resistant to moisture so that if there is a water or moisture leak, the seal created by the tape will not fail. Furthermore, the adhesive of the tape should stick well to multiple construction surfaces, such as wood, metal, concrete, wood composite or structural lumber, drywall, plaster, and plastic.

The construction tape of the present invention may also be used to create an air seal around heating and cooling vents in ceilings or floors, and around bathroom fans, or other places where energy inefficiencies are caused by unwanted air flow. These examples and other applications are possible and within the scope of the present invention even if the specific structures (e.g. width of the tape, width of the adhesive areas, etc) are not explicitly disclosed herein.

Accordingly, the spirit and scope of the present invention is to be limited only by the claims.

I claim:

1. Construction tape, comprising:
an inner surface having an adhesive area;
an outer surface having an adhesive area.

2. Construction tape of claim 1, wherein the inner surface further comprises a nonadhesive area.

3. Construction tape of claim 2, wherein the adhesive area of the inner surface comprises adhesive and extends from the top edge of the tape toward the center of the tape for the length of the tape; and wherein the nonadhesive area of the inner surface extends from the bottom edge of the tape toward the center of the tape for the length of the tape.

4. Construction tape of claim 3, wherein the adhesive on the inner surface is a pressure-sensitive adhesive.

5. Construction tape of claim 4, wherein the pressure-sensitive adhesive comprises butyl.

6. Construction tape of claim 1, wherein the adhesive area on the outer surface comprises adhesive.

7. Construction tape of claim 6, wherein the adhesive is a pressure-sensitive adhesive.

8. Construction tape of claim 7, wherein the pressure-sensitive adhesive comprises butyl.

9. Construction tape of claim 1, wherein the adhesive area is the entire outer surface.

10. Construction tape of claim 1, wherein the adhesive area on the outer surface is less than the entire outer surface area.

11. Construction tape of claim 10, wherein the adhesive area of the outer surface extends from the bottom edge toward the center of the tape for the length of the tape.

12. Construction tape of claim 1, wherein release material is applied to the adhesive area of the outer surface.

13. Construction tape of claim 12, wherein the release material is releasable on both sides

14. Construction tape of claim 12, wherein the release material is applied to the adhesive area of the outer surface prior to rolling the tape such that as the tape is unrolled for use, the adhesive of the inner surface releases from the release material and remains on the adhesive of the outer surface until it is released from the adhesive of the outer surface.

15. Construction tape of claim 12, wherein the release material, comprises perforation.

16. Construction tape of claim 15, wherein the perforation extends continuously for the length of the tape.

17. Construction tape, comprising:
an inner surface having an adhesive area and a nonadhesive area, wherein the adhesive area of the inner surface comprises adhesive and extends from the top edge of the tape toward the center of the tape for the length of the tape and wherein the nonadhesive area of the inner surface extends from the bottom edge of the tape toward the center of the tape extending the length of the tape;
an outer surface having an adhesive area, wherein the adhesive area of the outer surface comprises adhesive and extends from the bottom edge toward the top edge for the length of the tape; and
a release material applied to the outer surface, wherein the release material is. releasable on both sides.

18. A method of preventing unwanted airflow between conditioned and unconditioned spaces of a structure using the construction tape of claim 17, comprising:
a) adhering the inner surface adhesive area of the construction tape to a top plate of a framed wall;
b) applying ceiling cladding to ceiling joists;
c) exposing the adhesive area of the outer surface; and
d) adhering the exposed adhesive area of the outer surface to the ceiling cladding.

19. A method of preventing unwanted airflow between conditioned and unconditioned spaces of a structure using the construction tape of claim 17, comprising:
a) adhering the inner surface adhesive of the construction tape to a bottom plate of a framed wall;
b) applying cladding to the framed wall;
c) exposing the adhesive area on the outer surface; and
d) adhering the adhesive area of the outer surface to the wall cladding.
